(19) United States
(12) Patent Application Publication
(10) Pub. No.: US 2008/0319975 A1
(43) Pub. Date: Dec. 25, 2008

(54) Exploratory Search Technique

(75) Inventors: Daniel Scott Morris, Redmond, WA (US); Meredith June Morris, Redmond, WA (US); Gina Danielle Venolia, Bellevue, WA (US); Ryen William White, Kirkland, WA (US); Eric Horvitz, Kirkland, WA (US); Steven M. Drucker, Bellevue, WA (US)

Correspondence Address: MICROSOFT CORPORATION;C/O LYON & HARR, LLP, 300 ESPLANADE DRIVE, SUITE 800, OXNARD, CA, 93036, US

(73) Assignee: Microsoft Corporation, Redmond, WA (US)

(21) Appl. No.: 11/767,142

(22) Filed: Jun. 22, 2007

(51) Int. Cl. G06F 17/30

(52) U.S. Cl. 707/5

(57) ABSTRACT

A technique for the creation of synthesized results from multi-query searches to provide more relevant information to the user in a more useful format and to discard or reduce in relevancy information that is not so useful. It allows a user to define the boundaries of the exploratory search before it starts or retroactively define which queries belong to the search. It can imply which queries belong to the search based on parameters in the queries or results. It also provides mechanisms for supporting exploratory searches including: saving/restoring search context; search-specific query history; a “keepers” bin for storing useful results; elimination of redundant results; re-ranking of common search results; integration of searching with navigation; pivoting on search results; collaboration among multiple searchers; user-generated content; generation of hypotheses; re-executing queries and executing standing queries; multi-monitor searching and automatic preparation of search summaries. User interfaces for conducting multi-query searches are also provided.

### BACKGROUND

Exploratory searches are searches where there is uncertainty about the space being searched and the problem that motivates the search. An exploratory search typically begins with some certainties as to what is known and changes to more unfamiliar territory as the search progresses and the searcher finds and evaluates information. In conducting exploratory searches, users normally attempt to locate information in a search and then browse the search results.

Typically, when a user conducts an Internet or web search, each search query begins a brand new search from the perspective of the browser and search engine. If a user searches for “hybrid cars” and then immediately searches for “Toyota Prius,” the only evidence that the user ever submitted the first query is buried in their browser's history, despite the fact that these queries are clearly related. This may be fine for some searches, particularly short searches that only last for one or two queries. However, many searches extend over many individual queries, multiple search engines, multiple days and multiple computers. If one searches for “fun things to do in Paris”, it is likely to require many queries to complete this search. Current browsers/search engines do not provide any special support for this type of exploratory search or investigation. If a user attempts to perform such a search now they typically must manually write down their queries and record the addresses of important search results. This is cumbersome and often requires redundant work.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present exploratory search technique provides for the creation of synthesized results from multi-query searches, also referred to as exploratory searches, to provide more relevant information to the user in a more useful format and to discard or reduce in relevancy information that is not so useful. The present exploratory search technique can be deployed in terms of a stand alone application, within a web page or be integrated in a web browser.

In order to synthesize the search results the present technique delineates the boundaries of the search. The present technique provides for several mechanisms for delineating the boundaries of a multi-query search in order to synthesize the search results to provide a set of more relevant and useful search results. It allows a user to manually define the search before it starts or to define which queries belong to an exploratory search retroactively. One embodiment of the present exploratory search technique automatically determines which queries belong to an exploratory search based on parameters in the search queries or in the search results.

The technique also provides several other mechanisms for providing explicit support for this type of multi-query search. These mechanisms include: saving and restoring search context; search-specific query history; a “keepers” bin for storing useful results; elimination of redundant results; re-ranking of common search results; integration of searches with navigation; pivoting on search results to access information that is linked to the result; collaboration among multiple searchers; user-generated content; a user interface that allows a user to label search results as evidence for or against a hypotheses; re-executing queries and executing standing queries; multi-monitor searching and automatic preparation of search summaries.

The present exploratory search technique also provides for three exemplary user interfaces for conducting multi-query searches and supporting the mechanisms discussed in the paragraph above.

It is noted that while the foregoing limitations in existing search schemes described in the Background section can be resolved by a particular implementation of the present exploratory search technique, this is in no way limited to implementations that just solve any or all of the noted disadvantages. Rather, the present technique has a much wider application as will become evident from the descriptions to follow.

In the following description of embodiments of the present disclosure reference is made to the accompanying drawings which form a part hereof, and in which are shown, by way of illustration, specific embodiments in which the technique may be practiced. It is understood that other embodiments may be utilized and structural changes may be made without departing from the scope of the present disclosure.

### DESCRIPTION OF THE DRAWINGS

The specific features, aspects, and advantages of the disclosure will become better understood with regard to the following description, appended claims, and accompanying drawings where:

FIG. 1 is a diagram depicting a general purpose computing device constituting an exemplary system for a implementing a component of the present exploratory search technique.

FIG. 2 provides an overview of the environment in which searches are typically carried out.

FIG. 3 is a diagram depicting one exemplary architecture of the present exploratory search technique.

FIG. 4 is a flow diagram depicting a generalized exemplary embodiment of a process employing the present exploratory search technique.

FIG. 5 is a flow diagram depicting a more detailed exemplary embodiment of a process employing the present exploratory search technique wherein the beginning of the multi-query search is manually delineated by a user before the start of an exploratory search.

FIG. 6 is a flow diagram depicting a more detailed exemplary embodiment of a process employing the present exploratory search technique wherein the beginning and end of the multi-query search are retroactively manually delineated by a user.

FIG. 7 is a flow diagram depicting a more detailed exemplary embodiment of a process employing the present exploratory search technique wherein the beginning and end of the multi-query search are automatically implied by the present technique.

FIG. 8 shows a general user interface employed in one embodiment of the present exploratory search technique showing both a browser window and an exploratory search window.

FIG. 9 shows a first exemplary user interface of an exploratory search window.

FIG. 10 shows a second exemplary user interface of an exploratory search window.

FIG. 11 shows a third exemplary user interface of an exploratory search window.

FIG. 12 depicts a technique for eliminating redundant search results employed in one embodiment of the present exploratory search technique.

FIG. 13 depicts a technique used for boosting the relevancy of a search result employed in one embodiment of the present exploratory search technique.

FIG. 14 depicts another technique used for boosting the relevancy of a search result employed in one embodiment of the present exploratory search technique.

FIG. 15 depicts one embodiment of the user interface for the exploratory search technique wherein a search results summary is automatically displayed.

### DETAILED DESCRIPTION

1.0 The Computing Environment

Before providing a description of embodiments of the present Exploratory search technique, a brief, general description of a suitable computing environment in which portions thereof may be implemented will be described. The present technique is operational with numerous general purpose or special purpose computing system environments or configurations. Examples of well known computing systems, environments, and/or configurations that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, programmable consumer electronics, network PCs, minicomputers, mainframe computers, distributed computing environments that include any of the above systems or devices, and the like.

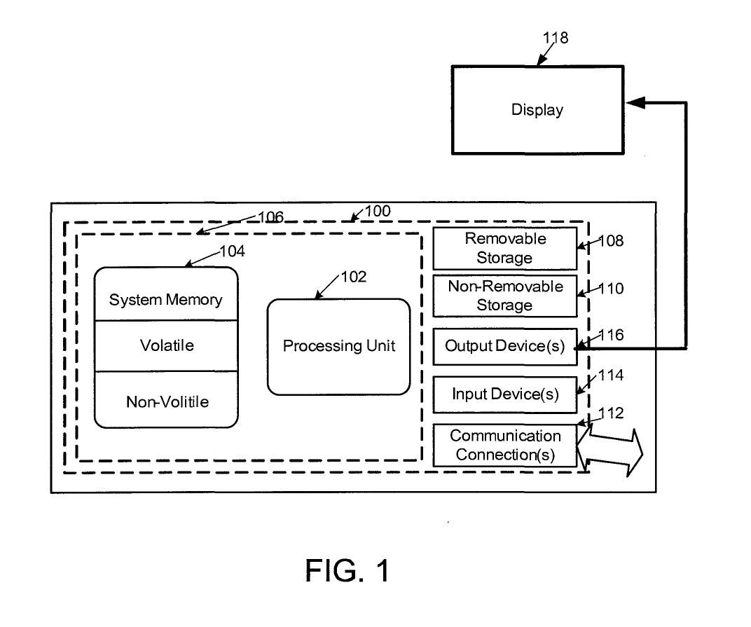

FIG. 1 illustrates an example of a suitable computing system environment. The computing system environment is only one example of a suitable computing environment and is not intended to suggest any limitation as to the scope of use or functionality of the present exploratory search technique. Neither should the computing environment be interpreted as having any dependency or requirement relating to any one or combination of components illustrated in the exemplary operating environment. With reference to FIG. 1, an exemplary system for implementing the present exploratory search technique includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106. Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

Device 100 has a display 118, and may also contain communications connection(s) 112 that allow the device to communicate with other devices. Communications connection(s) 112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Device 100 may have various input device(s) 114 such as a keyboard, mouse, pen, camera, touch input device, and so on. Output device(s) 116 such as a speakers, a printer, and so on may also be included. All of these devices are well known in the art and need not be discussed at length here.

The present exploratory search technique may be described in the general context of computer-executable instructions, such as program modules, being executed by a computing device. Generally, program modules include routines, programs, objects, components, data structures, and so on, that perform particular tasks or implement particular abstract data types. The present exploratory search technique may also be practiced in distributed computing environments where tasks are performed by remote processing devices that are linked through a communications network. In a distributed computing environment, program modules may be located in both local and remote computer storage media including memory storage devices.

The exemplary operating environment having now been discussed, the remaining parts of this description section will be devoted to a description of the program modules embodying the present exploratory search technique.

2.0 Exploratory Search Technique

The present exploratory search technique provides for the creation of synthesized results from multi-query searches, also referred to as exploratory searches, and to provide them in a format that a user can more easily manipulate and use. The present technique provides for several mechanisms for delineating a multi-query search in order to synthesize the search results. The synthesis of search results, as described herein, refers to the manipulation of a collection of search results into a cohesive set of more relevant and useful results. It allows a user to manually define the search before it starts or retroactively define which queries belong to an exploratory search. One embodiment of the present exploratory search technique automatically determines which queries belong to an exploratory search based on parameters in the search queries or in the search results.

2.1 Background/Anatomy of a Search

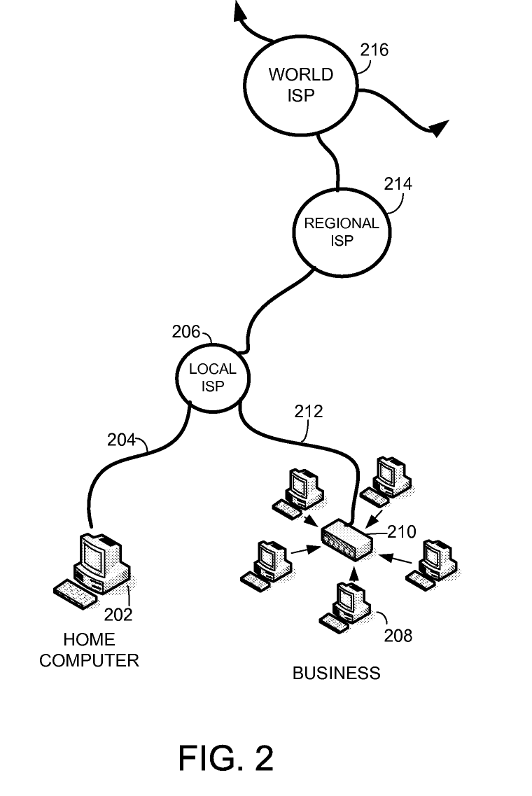

FIG. 2 provides an overview of the environment in which searches are typically carried out. Typically, the present technique will search for information on the Internet, a Local Area Network (LAN) (e.g., inside a business) or even on a user's computer. As such, a brief description of the operations of such a search is helpful.

The Internet is a collection of millions of computers linked together on a computer network. The network allows the networked computers to communicate with one another. A home computer 202 may be linked to the Internet using a phone line and a modem, digital subscriber line (DSL) or a cable modem 204 that talks to an Internet service provider (ISP) 206. A computer in a larger entity such as a business will usually have a network interface card (NIC) that directly connects it to a local area network (LAN) 210 inside the business. The business can then connect its LAN 210 to an ISP 206 using a high-speed phone line like a T1 line 212. ISPs then connect to larger ISPs 214, and the largest ISPs 216 maintain fiber optic “backbones” for an entire nation or region. Backbones around the world are connected through fiber-optic lines, undersea cables or satellite links. In this way, every computer on the Internet is connected to every other computer on the Internet.

There are millions of pages of information available on the Internet or World Wide Web. When a person seeks to find information on a particular subject they are most likely to visit an Internet search engine via a browser. Internet search engines are special sites on the Web that are designed to help people find information stored on other sites. Although there are differences in the ways different search engines work, they all perform three basic tasks. First of all, they search the Internet (or other networks or databases) based on important words. Secondly, they keep an index of the words they find and where they find them. Lastly, they allow users to query or look for words or combinations of words in that index.

Before a search engine can provide information to a user as to where a file or document is, it must be found. To find information on the Web, a search engine employs special software robots, called spiders, to build lists of the words found on Web sites by a process called web crawling. Once the spiders have completed the task of finding information on Web pages, the search engine must store the information in a way that makes it useful. Usually this involves storing the indexing the information and storing it.

In the simplest case, a search engine can store the word and the address or uniform resource locator (URL) where it was found. However, this makes for an engine of limited use, since the importance of a word on a web page is not recorded. This is problematic in determining the relevancy or ranking of search results. To make for more useful results, most search engines store more than just the word and URL. An engine typically stores the number of times that the word appears on a page, or assigns a weight to each entry, with increasing values assigned to words as they appear near the top of the document, in sub-headings, in links, in the meta tags or in the title of the page. Each commercial search engine has a different formula for assigning weight to the words in its index.

Searching through the index to find information involves a user building a query and submitting it through the search engine. The query can be a single word or more complex using Boolean operators that allow a user to refine and extend the terms of the search. Such queries are typically submitted via a browser. A web browser is a software application that enables a user to display and interact with text, images, and other information typically located on a web page at a website on the World Wide Web or a local area network. Text and images on a web page can contain hyperlinks to other web pages at the same or different website. Web browsers allow a user to quickly and easily access information provided on many web pages at many websites by traversing these links. Web browsers communicate with web servers primarily using HTTP (hypertext transfer protocol) to access web pages. HTTP allows web browsers to submit information to web servers as well as fetch web pages from them. Web pages are located by means of a URL which is treated as an address.

2.1 Exemplary Architecture of the Present Exploratory Search Technique.

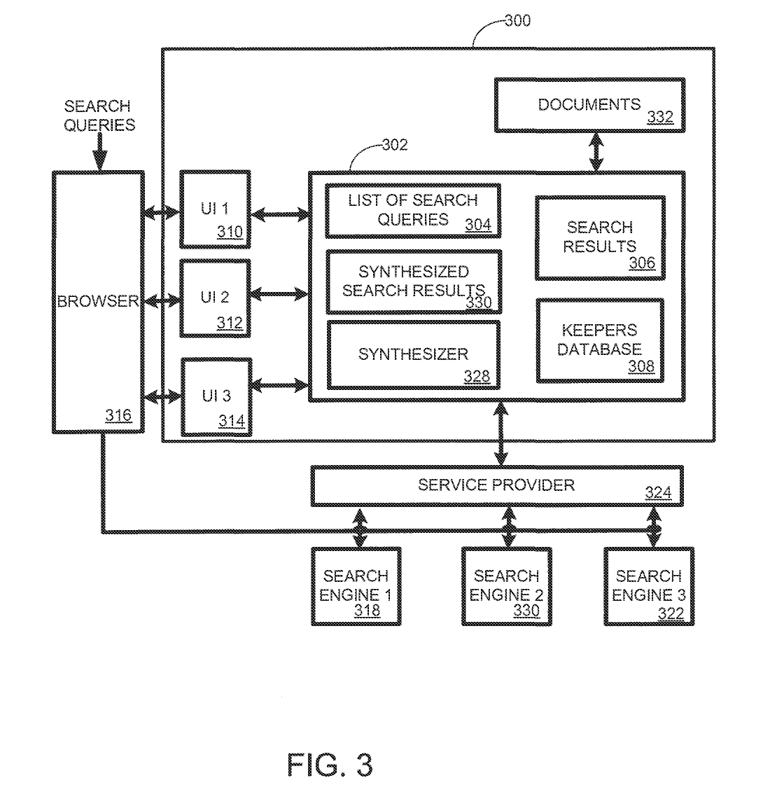

One exemplary architecture of the present exploratory search technique 300 is shown in FIG. 3. The exploratory search module 302, which processes the search queries that are typically input into a search engine 322, 313, 330 via a browser 316, resides on a computing device 100, such as discussed with respect to FIG. 1. The exploratory search module 302 consists of a module that stores a set of the multiple search queries and query related histories 304, a module that stores search results 306, and a database of search results 308 that have been designated with information about how a user interacted with each result. For example, results may be sorted in the database, along with the meta data that describes wither the user visited, “kept” or “trashed” that search result. Search results designated as important to a multi-query search can be termed as “keepers”. The keepers may be defined by input from a user or may be automatically generated. A user can also designate search data to be discarded as “trash”. For purposes of this description this database 308 can alternately be referred to as the keeper's bin. The exploratory search module 302 interfaces with one or more user interfaces 310, 312, 314 which interface with a browser 316. Searches or queries are executed using the browser 316, one or more search engines 318, 320, 322 and a network service provider 324 which provides access to a network, such as the Internet. The service provider and search engines search data sites (e.g., on the Internet) and supply the search results back to the exploratory search module 302 for synthesis. Such synthesis can include, for example, elimination of redundant results, re-ranking the relevancy of the search results, a user interface that allows a user to label data as for, against or not pertaining to an existing hypothesis, automatic preparation of a search summary or incorporating user annotations into the search results. The exploratory search module synthesizes these search results in a synthesizer 328 (which performs the computations necessary to synthesize the search results using the databases of search results 306, 308, 330 and the search queries 304) and stores them in a synthesized search results database 330. The user can further manipulate the synthesized search results by, for example, browsing the search results, pivoting on the search results to find data linking to them, and requesting an automated search summary. The user actions are typically performed using one of the user interfaces 310, 312, 314. The exploratory search module can also generate documents 332 using the queries 304 and the synthesized search results 330, the original search results 306 or the keeper's bin 308.

2.2 Exemplary Process Employing the Present Exploratory Search Technique.

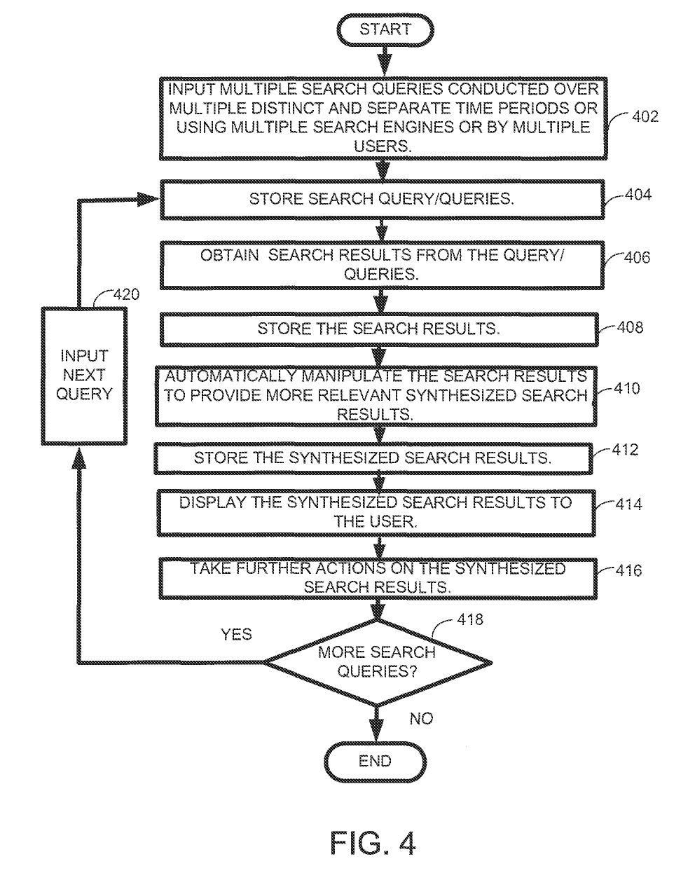

An exemplary process employing the exploratory search technique is shown in FIG. 4. In a very general sense, the technique operates as follows. Multiple search queries are input (box 402). These multiple search queries can be conducted over multiple distinct and separate times (e.g., days or weeks). They can also be performed using multiple search engines or can be generated by multiple users. The search queries, and any related query histories, are stored for later access (box 404). Once the multi-query searches are input the search results are obtained (box 406) and stored (box 408). The exploratory search technique automatically manipulates the multiple search results to provide more relevant or useful synthesized results of the multiple search queries to the user (box 410). The synthesized results can be in part based on the data in the keeper's database. The manipulation can include, for example, the elimination of redundant results, re-ranking the relevancy of the search results, providing a hypothesis, automatic preparation of search summaries, and incorporating user annotations into the results. These synthesized results are then stored (box 412) and displayed to the user (box 414). The user can then view and take further action on these results (box 416). As stated previously, the user can further manipulate the synthesized search results by, for example, browsing the search results, pivoting on the search results to find data linking to them or requesting an automated search summary. If more search queries are input (boxes 418, 420) the process repeats using the next input search query to further manipulate the search results.

2.2.1 Delineating a Multi-Query Search:

In performing the synthesis action, it is important for the present exploratory search technique to know where the investigation or multi-query search starts and stops. Typically, it is quite difficult for a browser or engine to look at a series of queries and decide that they are related or not, and this is something missing from current search engines. The present exploratory search technique employs several mechanisms to define where a multi-query (e.g., exploratory) search is started and stopped.

2.2.1.1 Manual Delineation of Search Boundaries:

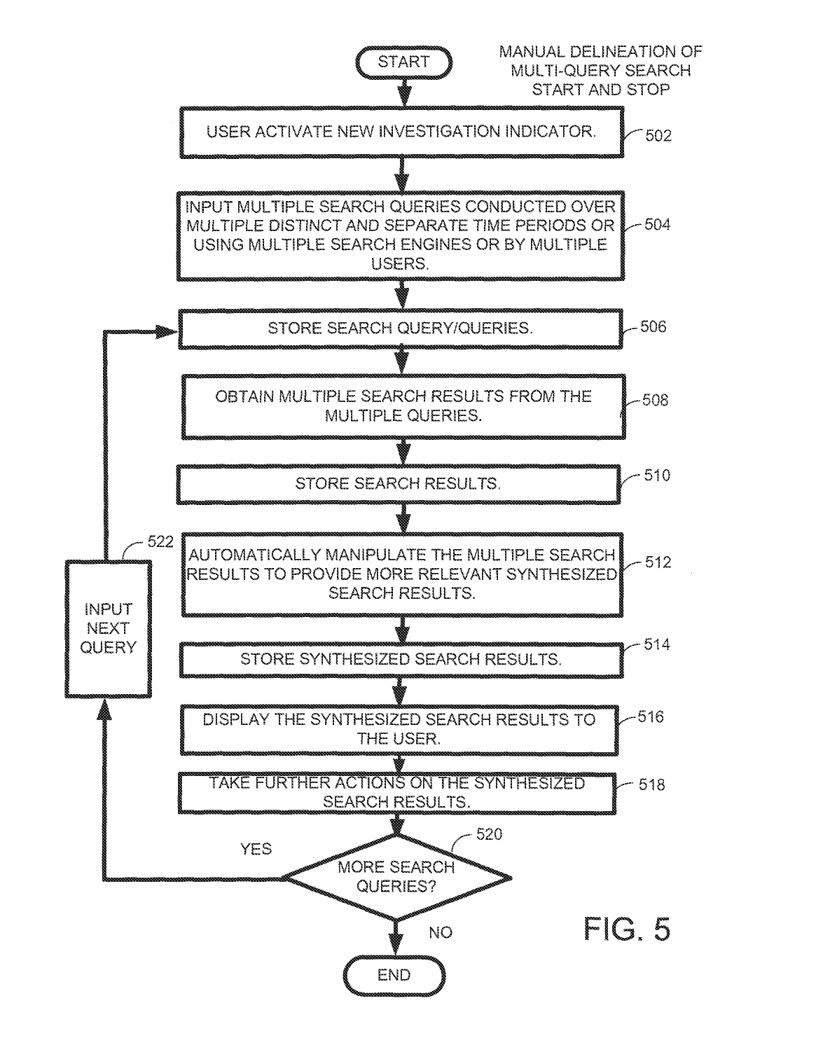

In one embodiment, in order to delineate the boundaries of the multi-query or exploratory search, the user activates a “new search” control button before they submit a series of related queries. Many of the embodiments of the user interfaces for the present exploratory search technique have some form of a “new search” button. This search (bundle of queries) can then be explicitly assigned a name (by asking the user to enter text) or automatically assigned an identifier such as a name (for example, by using the first query, the last query or words common to all the queries). More specifically, one exemplary embodiment of the present exploratory search technique wherein a user manually delineates the search boundaries, shown in FIG. 5, operates as follows.

A user activates a new investigation control, for example, by clicking on a “new search” button with an input device (box 502). Multiple search queries are then input (box 504). As mentioned previously, these multiple search queries can be conducted over multiple distinct and separate times (e.g., days or weeks). They can also be performed using multiple search engines or can be generated by multiple users. The search queries (and any associated query histories) are stored for later access (box 506). The search results are obtained (box 508) and stored (box 510). The exploratory search technique automatically manipulates the multiple search results to provide more relevant or useful synthesized results of the multiple search queries to the user (box 512). These synthesized results are then stored (box 514) and displayed to the user (516) who can then view and take further action on these results (box 518). If more search queries are input (boxes 520, 522) the process repeats using the next input query to further manipulate the search results.

2.2.1.2 Retroactive Delineation of Search Boundaries:

In many cases the user may submit a query or two using their browser, initially assuming that their search will be brief, but then their search grows in complexity. In this case it is desirable for the user to specify that that the user's last few queries are related. One approach-if the user has access to a list of recent queries-is to let the user highlight a few queries and specify that these queries are to be bundled into a search. Another approach is to let the user select all of the queries that they have submitted recently that contain any of the desired keywords, and bundle them into an exploratory/multi-query search. Yet another approach is to let the user select all of the documents that they have open at the time, and bundle them into an exploratory search.

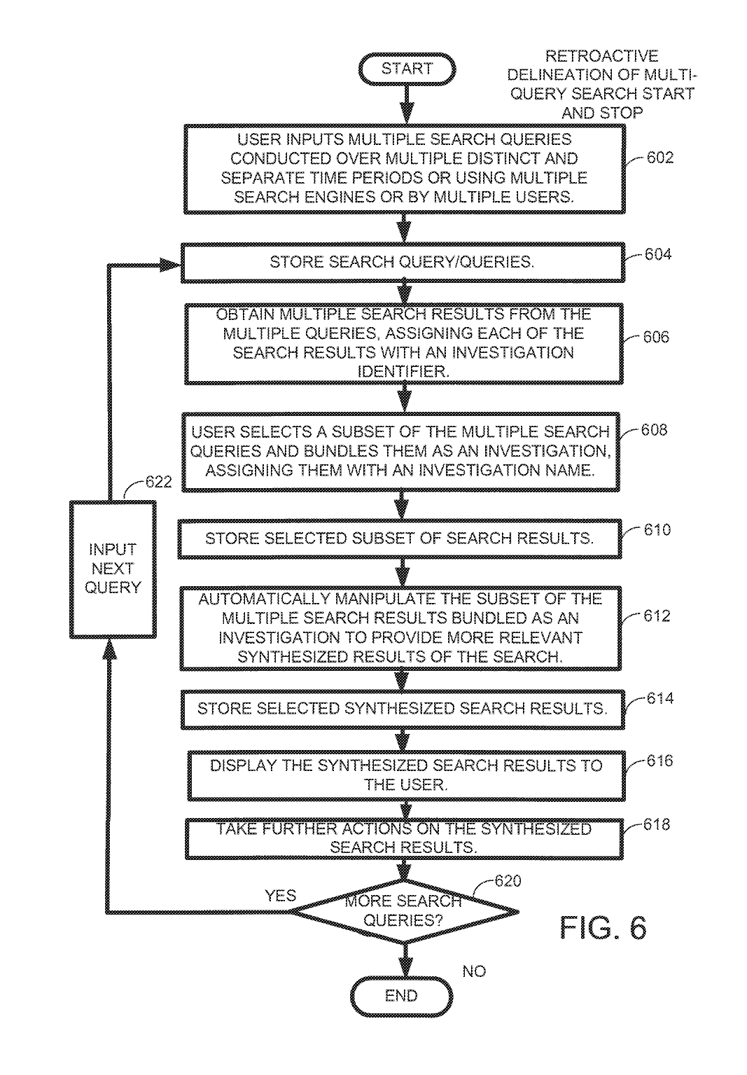

One embodiment of the present exploratory search technique that allows a user to retroactively delineate the boundaries of multi-query searches is shown in FIG. 6. Multiple search queries are input (box 602). The search queries are stored for later access (box 604). Once the multi-query searches are input the search results are obtained (box 606). The user then bundles the multiple search queries (e.g., in one of the methods discussed in the paragraph above) which can be assigned with an identifier such as an investigation name (box 608). The selected subset of the search results are stored (box 610) and the exploratory search technique automatically manipulates the bundled queries and associated search results to provide more relevant or useful synthesized results of the multiple search queries to the user (box 612). These synthesized results are then stored (box 614) and displayed to the user (box 616) who can then view and take further action on these results (box 618). If more search queries are input (box 620, 622) and the process repeats.

2.3.1.3 Automatic Delineation of Search Boundaries:

Ideally, if the user is submits 10 queries about a given subject, for example, hybrid cars, the user's browser/search engine should figure this out and present the user with an exploratory search user interface. The present exploratory search technique automatically bundles queries into a search by looking for one or more of the following:

Overlap in terms used in recent queries or proximity in a pre-defined network of semantic relationships among queries (e.g. ways in which semantics can be used to group queries). One example is a thesaurus lookup. If the present technique encounters the query “good dogs” followed by the query “great canines”, it will find that both words in the second query appear in a thesaurus entry for one of the words in the first query, implying a close semantic relationship. In one embodiment the technique will thus determine that these queries are part of a single search;

Overlap in results returned for recent queries; and

Temporal relationship of recent queries (e.g., queries conducted in rapid succession are likely to be part of a single search).

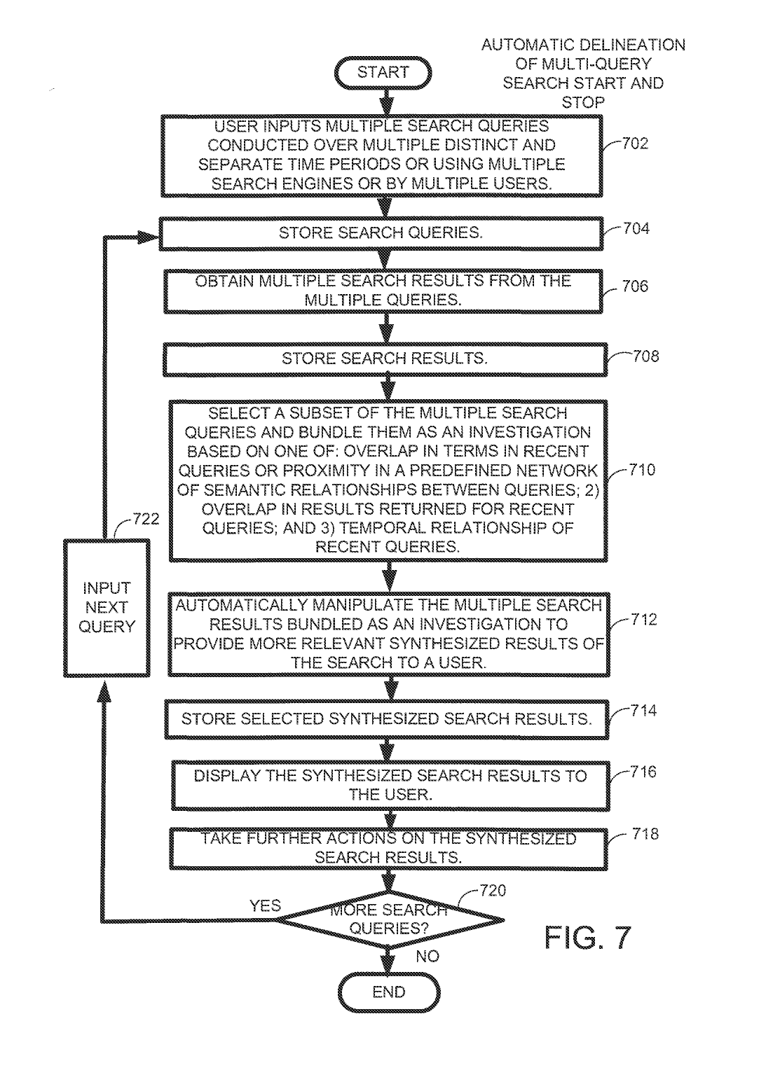

One embodiment of the present exploratory search technique that provides automatic delineation of multi-query searches is shown in FIG. 7. Multiple search queries are input (box 702). These multiple search queries can be conducted over multiple distinct and separate times (e.g., days or weeks). They can also be performed using multiple search engines or can be generated by multiple users. The search queries are stored for later access (box 704). The search results are obtained (box 706) and stored (box 708). The system then bundles a subset of the multiple search queries and associated search results (e.g., using one of the methods discussed in the paragraph above) (box 710). The exploratory search technique automatically manipulates the bundled queries and associated search results to provide more relevant or useful synthesized results of the multiple search queries to the user (box 712). These results are then stored (box 714) and displayed to the user (box 716) who can take additional actions on the data (box 718). If more search queries are input (boxes 720, 722) the process repeats.

2.4 Details and Exemplary Embodiments

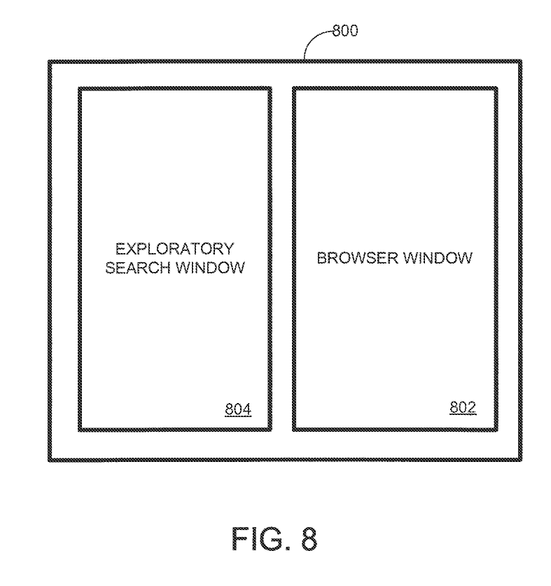

FIG. 8 provides an exemplary user interface 800 displayed on a computing device's display that is employed in one embodiment of the present exploratory search technique. In this user interface 800, a typical browser window is displayed 802, as is an exploratory search window 804. In the following discussions of the exemplary user interfaces of the exploratory search technique, the user interfaces discussed are typically displayed in the exploratory search window 804.

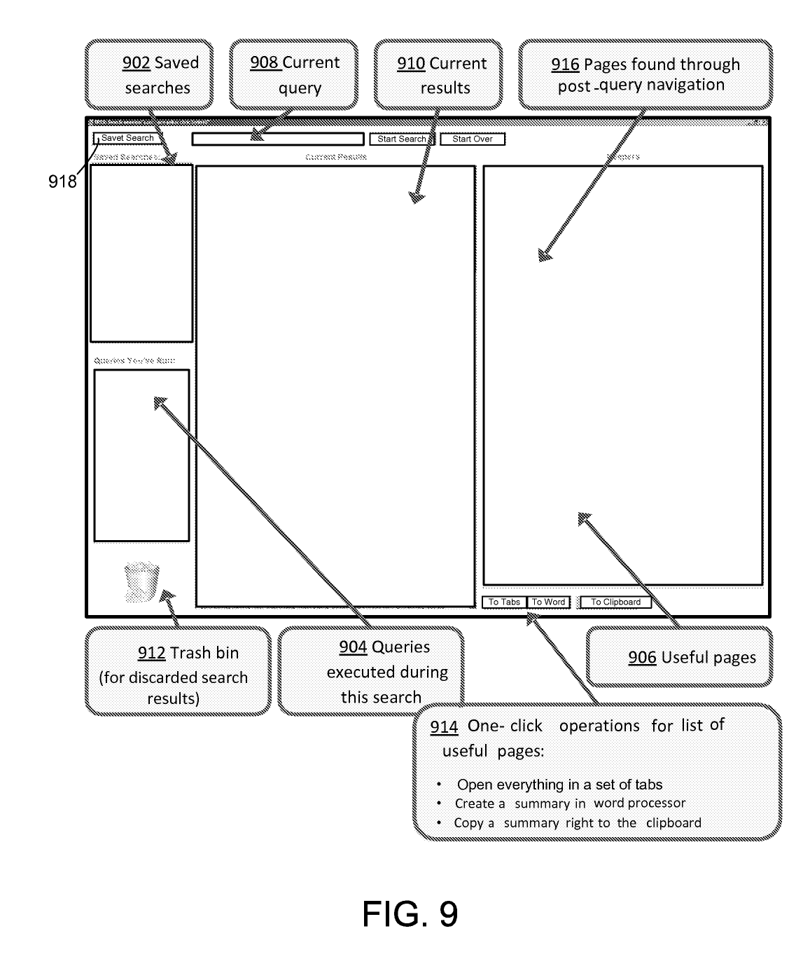

The present exploratory search technique can be described in terms of three exemplary embodiments, each supporting a different subset of features that support exploratory searches. The present exploratory search technique is, however, not limited to these three particular embodiments, parts of which can be used separately, combined in different combinations, or integrated into a single application. It should be noted that while the features of the present exploratory search technique are described in terms of a stand alone application, these features can also be employed with a web page or in a web browser. FIGS. 9, 10 and 11 show user interfaces for relevant features of these exemplary embodiments of the present exploratory search technique. The features of the present technique are described in the paragraphs below.

2.3.1 Saving and Restoring Search Context.

Searches often extend over multiple sessions, so it is extremely helpful to have a mechanism for saving and restoring an entire search context. For example, a person might be planning a vacation to Paris, but get interrupted while they are searching for information on Paris. They might have a few windows or tabs open that contain interesting web pages, and they might have just executed a number of queries. If they do not have a chance to return to this search for a few days, it will be very hard to get their computer and search engine back to this state. More importantly, it may be very hard for them to remember which pages they visited, which pages were useful, which queries they executed, which queries turned out to be useful, and so on. It is very likely that they would need to perform much redundant work.

The present exploratory search technique supports saving and loading of an entire search context-recent queries, pages that were interesting, pages they visited, and pages they had open-to facilitate easily resuming a suspended search. This is done by accessing stored search queries and associated search results and pages visited or marked as useful during that search. In FIG. 9, a list of saved searches is saved in a saved searches window 902. Clicking on any of these saved searches in this window immediately brings up the list of queries that the user executed during that search in a query window 904. Additionally, a list of pages the user visited and/or marked as useful during that search is provided in a useful page window 906. The current query is also displayed in a current query pane 908. Finally, a set of current results is also provided in a separate window 910. The user can switch briefly to another search and switch right back, or they can shut down their computer for weeks and quickly resume each search later. Pages found useful through post-query navigation (e.g., browsing the search results) are also displayed in the useful page window 906. The user can create a saved search by clicking a “save search” control button 918, and future operations on that search (e.g., executing new queries) will be automatically saved.

2.3.2 Search-Specific Query History.

It is helpful for a user to see the history of recently executed searches when conducting an exploratory search, to avoid redundant querying, to see the progression of their queries over time, and to quickly re-execute promising queries. The present exploratory search technique provides to the user a list of queries within the current search which are displayed to the user (FIG. 9, 904). This feature is very different than the history maintained by the browser. Although a browser typically does store all visits to search engine sites in its history, this browser history mixes queries with non-search navigations, mixes queries from one search with queries from another search, and does not strip away title information that is not relevant to quickly seeing what the query text was.

2.3.3 “Keepers” Bin for Storing Useful Results.

The present exploratory search technique helps a user to keep track of web pages that they like, and do not like, and uses that data to improve their search results. It provides an explicit record of “useful” pages identified during a search, particularly a multi-query search. For example, these might be the pages the user will look at later to learn more about a topic, the products a user will compare at the end of their search, or the pages they will e-mail to their boss or a collaborator, for example.

As discussed previously, the present exploratory search technique provides a “keepers” bin or database for storing the results designated as useful pages that have been identified in a search (FIG. 9, 906), and allows the user to place sites in this bin via explicit or implicit mechanisms. In one embodiment, the user can classify search results received from a given query as useful or non-useful by selecting a thumb's up indicator or a thumb's down indicator, respectively. Additionally, the user can explicitly drag a link to the data in this bin to save the result from inside an embodiment of the exploratory search application or from another application. The user can implicitly add results to this bin by spending a long time viewing a page, by performing complex interactions with a page, or by following a link from another page that is already in the keepers bin. All of these things tell the exploratory search application that the user is probably interested enough in this page to keep it for later use.

This set of “keeper” pages is immediately useful to the user, but it also has several uses that are more subtle. If a page is marked as a “keeper” (e.g., it is saved in the keepers bin), the present exploratory search technique may invest more computational resources on that page, for example to save it for offline storage, to pre-fetch it for rapid viewing, or to generate a thumbnail representation for the page. Furthermore, information about pages the user finds useful can serve as input to relevance feedback systems that improve the ranking of future pages. It should be noted that systems that ask the user to mark pages as “good” or “bad” have been unsuccessful because the user is generally not motivated to provide such feedback, but here the feedback is given implicitly by the fact that the user has chosen to keep a result.

2.3.4 Elimination of Redundant Results

In the course of a multi-query search, a user often sees the same results repeatedly, whether they are useful or not. This is problematic given the documented fact that most users are reluctant to view more than a single page of search results. In other words, redundant results limit the total number of results that a user will view in the course of a search. The present exploratory search technique takes two different approaches to eliminating redundant results.

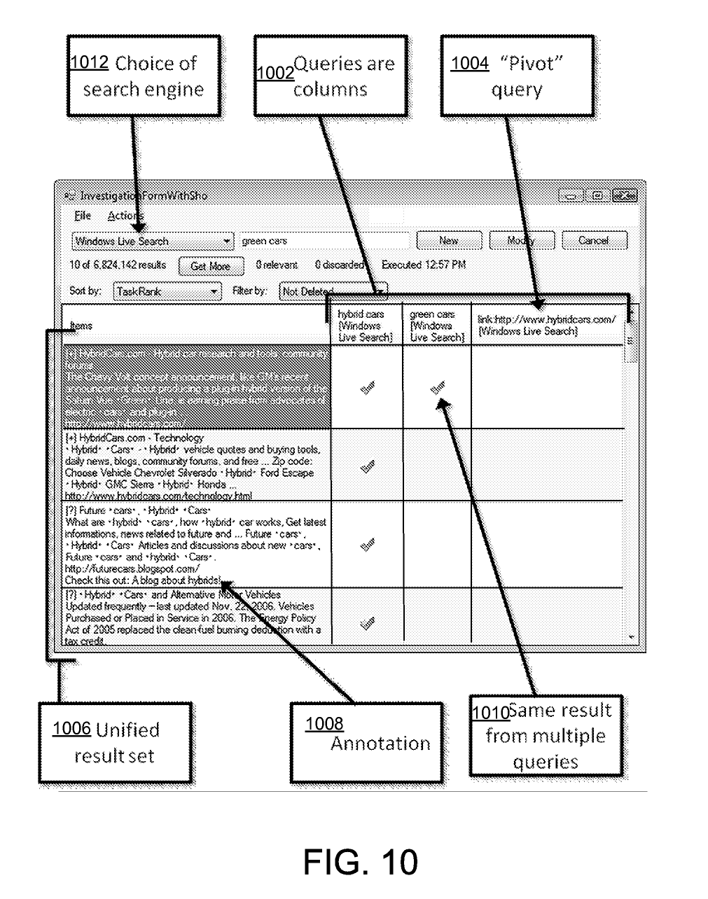

In one exemplary embodiment, an exemplary user interface 1000 of which is shown in FIG. 10, the result sets from multiple searches are combined into a grid 1002, 1006. A particular URL that results from multiple queries appears only once in the grid, with a checkmark in each column whose query returned it 1002, 1010. If a URL has been marked as “trash” (e.g., it has been marked to be discarded), it will not reappear even if it is returned by a subsequent query.

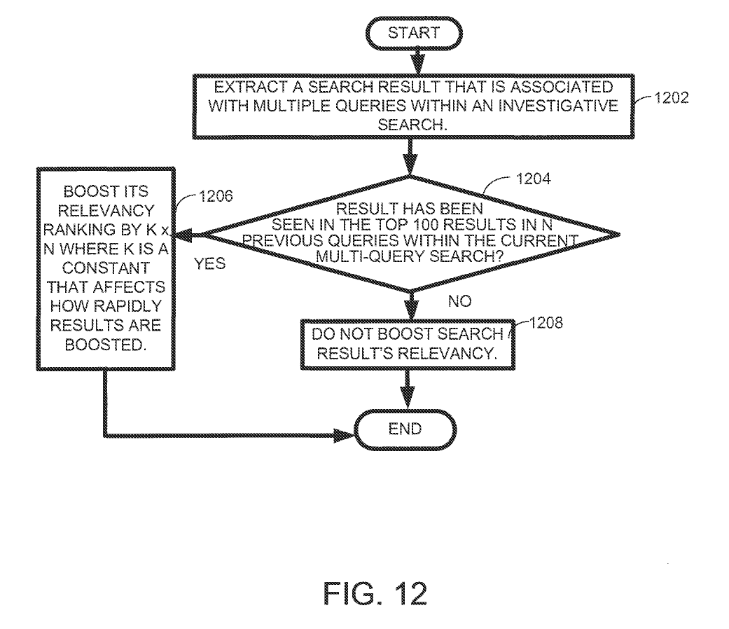

In another exemplary embodiment, the exemplary user interface of which is shown in FIG. 9, redundant results are handled in a different way. Before displaying search results to a user, this embodiment eliminates results that have been (1) put in the keepers bin, (2) explicitly marked as “trash” (FIG. 9, 912), or (3) implicitly marked as not-useful by being ignored repeatedly. The present exploratory search technique can employ several mechanisms for allowing a page to be implicitly marked as not-useful. For example, a result that the user sees a fixed number of times and does not interact with is probably not useful, and can be demoted in relevance or hidden in future queries. Or if a user does not interact with a result, but that result appears above a result (e.g., is determined to have a higher relevancy rating) that the user does interact with a certain number of times, that result is probably not useful. For example, if multiple searches are executed and the search third result is the same in each case, if the user views, keeps, or discards the fourth result, the user very likely saw the third result (it is a documented fact that users tend to read search results top-down), and in one embodiment the present exploratory search technique can de-rank the third items relevancy or hide it if it comes up again in future queries. This reduces redundancy in search results across multiple queries within a search. FIG. 12 shows an exemplary embodiment of eliminating redundant results. Multiple search queries are received from a user, each of the multiple search queries being associated with search results (box 1202). It is determined which search results are to be kept and which are to be discarded (box 1204). The search results determined to be discarded are discarded (box 1206). Subsequent search queries are performed, each being associated with subsequent search results (box 1208). If a subsequent search result has been seen discarded previously, the subsequent search result is discarded (box 1210) If a subsequent search result has not been discarded previously, the subsequent search result is displayed (box 1212).

2.3.5 Re-ranking the Relevancy of Common Results:

Typical search engines attempt to rank query results using a variety of factors, all of which try to estimate each result's relevance to the user's query. However, current search engines do not typically attempt to use information about recent queries to improve result ranking. This may be problematic, since a result that is ranked 20^{th} for all of a set of queries within a search is probably very relevant, but the user will probably never see it, because it never entered the top 10 results that are viewed by a typical user. In one embodiment the present exploratory search technique boosts the ranking of results that are associated with multiple queries within a search.

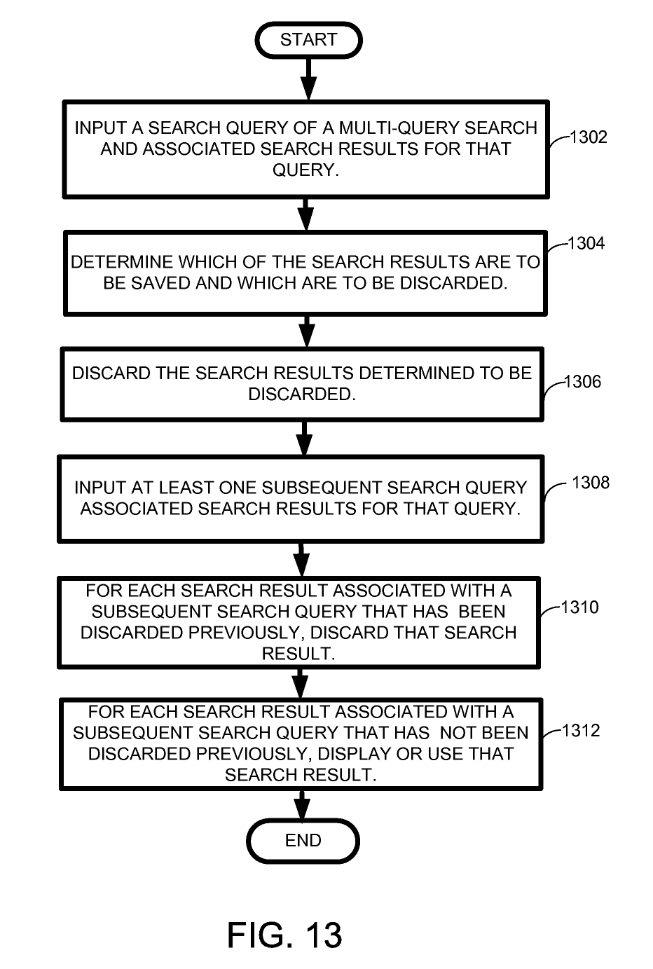

One process employed by the present exploratory search technique for using search results to improve the relevancy rating of a search result is shown in FIG. 13. As shown in box 1302, a search result that is associated with a query in a multi-query search is extracted. If a result has been seen in the top 100 results in n previous queries within the current search, its ranking is boosted by k*n, where k is a constant that affects how rapidly results are boosted (boxes 1304, 1306). Otherwise, the relevancy is of the search result is not boosted (box 1308). For example, assume k=5, if the search engine tells the user that a result is ranked 20^{th} in a current query, but this same result has appeared 3 times before, it would be boosted up 5*3 or 15 places, to 5^{th}. If a result is boosted but ignored, the technique can use the previously-discussed mechanisms for eliminating it from future result sets to avoid redundancy.

Note that the technique above could also use a more sophisticated mechanism that scores each result against each previous query within this search.

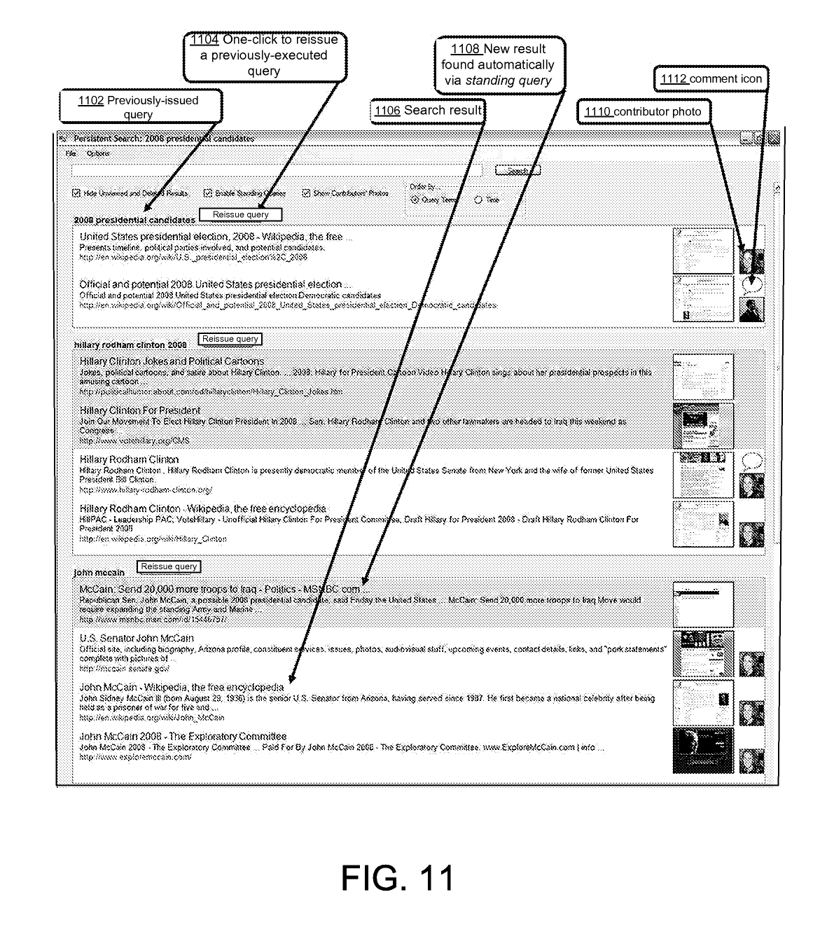

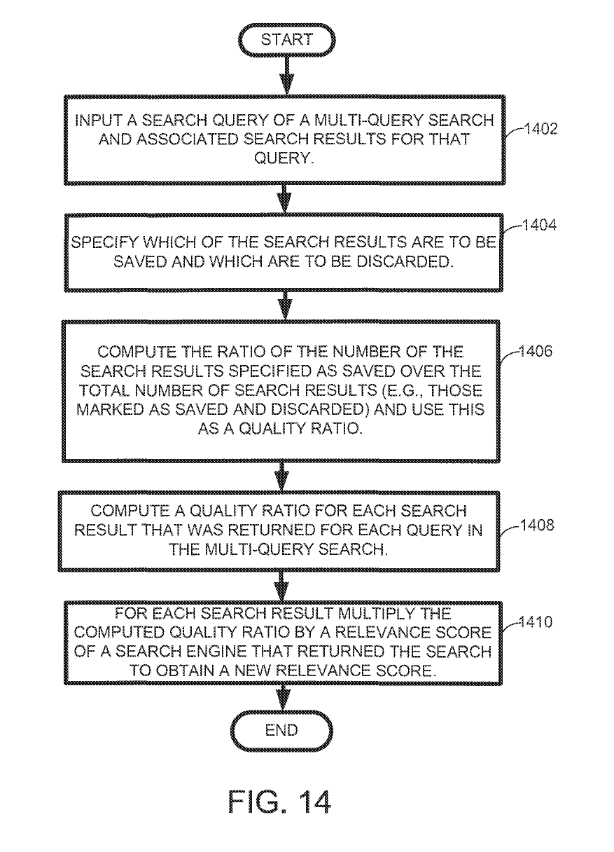

Another embodiment of the present exploratory search technique shown in FIG. 14 (the user interface of which is shown in FIG. 11) takes another approach to re-ranking. For each query of a multi-query search (box 1402) search results are either saved or discarded (box 1404). The ratio of the number of results marked “saved” versus the total number marked “saved” and “discarded” is computed (box 1406). This ratio gives a measure of the quality of the query with respect to the current search exploration task. For each search result the technique then computes the average quality ratio over all queries that returned the search result, weighted by the relevance score given by the search engine to that item (boxes 1408, 1410). The user can sort the grid rows by this re-ranked score.

2.3.6 Integration with Navigation:

Often a user will begin a search with a search engine query, then follow one of the result links to another page, where he will follow a few more links before he ends up at a page the provides relevant information. Besides keeping track of useful search results and storing the relevant events in a search session, the present exploratory search technique keeps track of post-query navigation events. To achieve this, one embodiment the present exploratory search technique has implemented a browser plug-in that tracks the user's navigation events and reports them back to the exploratory search application. If the user arrives at a series of useful pages after following a link from a search result, these pages are stored and displayed in condensed form along with the original search result (FIG. 9, 916).

2.3.7 Pivoting on Search Results: Navigation by Search.

In one embodiment, the present exploratory search technique follows the links between pages by “pivoting” on the search results. Pivoting occurs when a user chooses a search result and requests pages that link to the chosen search result. In one embodiment, (the user interface of which is shown in FIG. 10) the user can right-click on any result and choose to “find pages that link to this one”. This creates a new column (FIG. 10, 1002) representing the query for all such pages. More-sophisticated pivots are possible depending on the structure of the data being searched. For example a search engine over a patent database could provide the ability to pivot from a patent to all related patents or all authors, or from an author to all his patents. Pivots allow a kind of browsing without ever leaving the search UI. Previously existing search interfaces allow this operation only by text-based query, which limits its utility for browsing a result set.

2.3.8 Multiple Search Providers:

In complex search activities a user will often employ multiple search engines. One embodiment of the present exploratory search technique that provides a drop-down list box that allows the user to create a new query on a specified search engine is shown in FIG. 10, 1012. Additional search engines can be added using a simple plug-in architecture. Furthermore, a special plug-in can be employed to allow a query to be executed against all search engines simultaneously. The search results can then be interleaved in a round-robin fashion.

2.3.9 Collaboration Among Multiple Users

Current web search tools are designed for a single user, working alone. However, there are many scenarios where users may wish to collaborate on a search task. For example, friends planning a joint vacation may wish to search for plane tickets, hotels, and tourist activities together, or spouses planning to purchase of a new family car may wish to jointly conduct a search to learn about vehicle models, pricing, and safety ratings. By providing a persistent representation of a search, the present exploratory search technique creates the possibility for a collaborative search experience. For example, one embodiment of the present exploratory search technique stores each saved search session as a file on a user's local machine. If a first user performs a search on hybrid cars and then emails the saved search file to a second user, she or he can open it, view the current state of the search, and augment the search with additional query terms, search results marked as “keepers”, add comments to pages, and so on. To support collaboration, one embodiment of the present exploratory search technique indicates the identity of the user who added each search result to the workspace of “keepers” (FIG. 11, 1110) and who made each comment.

2.3.10 User-Generated Content:

One embodiment of the present exploratory search technique provides for the ability to add user-generated content. Studies of web search habits report that users often take notes (on paper, in a typed document or email) during a complex search process. Providing a means for users to associate notes directly with search results eliminates the need to have additional applications open during a search, thus freeing up screen real-estate and reducing the cognitive overhead of switching among several application windows. The ability to associate comments with search results also makes these notes easier to locate, can help provide a user with context to jog her memory when she revisits an old saved search session, and can provide helpful context to collaborators with whom a search session is shared. One embodiment of the present exploratory search technique allows a user to right-click on a search result, which brings up a dialog box allowing comment entry. The presence of a comment can be indicated via a special icon (FIG. 11, 1112) displayed alongside a search result. In one embodiment, hovering over the comment icon reveals the text of the comment. FIG. 10, 1008 shows a comment inline in the result set.

In one embodiment of the present exploratory search technique the UI has been extended (shown in FIG. 10) to support a different kind of user-generated content. The user is able to add a new column to the grid for user-specified values. When creating a column the user can specify both a name and a type for the column, e.g., integer, Boolean, date, dollars, etc. Each cell in the column contains a control appropriate for that type. Of particular interest are Boolean columns, consisting of a column of checkboxes. This allows the user to easily create subsets of the results useful for sorting or other operations.

2.3.11 Hypotheses: Support for Making Decisions

In one embodiment the present exploratory search technique creates a special type of column for hypotheses. A hypothesis is a relatively formal question that the user is trying to answer. For example if the general topic of the search is, “Which hybrid is the right one for me?” the hypotheses might be, “The Prius is the best choice,” “The Civic Hybrid is the best choice”. An item might support, refute, or not pertain to a hypothesis. In one embodiment of the present exploratory search technique a user interface is provided for defining a hypothesis and then associating a user element with each search result that the result either supports, refutes or does not pertain to the hypothesis. In one embodiment, this is controlled by a three-state checkbox-type control.

2.3.12 Re-executing a Query:

In one embodiment of the present exploratory search technique, selecting a previously-issued query (FIG. 11, 1102) and activating a reissue query control button 1104 automatically reissues that query and repopulates the list of current search results 1106 appropriately. This is enabled by saving a history of the results the user saw the last time they executed that query. The present technique can easily identify which results are new by comparing the search results of the re-executed query to the previous query. It can highlight those to make them particularly salient to the user. The exploratory search technique can also proactively treat all queries in the query list as “standing queries” 1108, and periodically check for the existence of new, highly ranked search results corresponding to the query, notifying the user (i.e., by highlighting that query term in the list) when new results for a previously-issued query have become available.

2.3.13 Support for Multi-Monitor Searching:

A rapidly-increasing number of desktop computer users have either multiple monitors or large, widescreen monitors. Currently, search engines and browsers do not explicitly take advantage of large displays. In fact, the typical search experience is extremely inefficient in its use of space. A user typically begins a web search in a browser window that consumes less than half the space on a large monitor. In order to browse the results returned the user has to either replace their search context by clicking on a link (which brings up the new page and makes the search disappear) or manually manage a series of new windows or tabs. Despite the fact that many users have extensive screen space available, there is no efficient way to browse through search results without hiding search context.

To solve this problem of hiding search context to display search results, in one embodiment the present exploratory search technique has implemented an extension to the exploratory search technique's user interface and a browser plug-in that allows a user to rapidly view web search results in another browser window without losing track of their search context. In both cases, right-clicking or hovering over search results brings them up in an automatically-positioned second browser window. Result pages are pre-fetched so they can be displayed quickly in the “preview” window. A user can then interact directly with that window, or he can click a result in his search window to hide the preview window and continue navigation as he normally would. For example, in the drawing shown in FIG. 8, when a user highlights a search results in the browser window 802, the results will be previewed/displayed in the exploratory search window 804. In a multiple monitor configuration the browser will display on one monitor, while the search results will be previewed/displayed on a second monitor.

This approach is extremely valuable not just for exploratory searches, but for virtually any search where multiple results will be viewed and multiple monitors-or one large monitor-is available. The multi-monitor browser plug-in is suitable for any web search application.

2.3.14 Automatic Preparation of Search Summaries:

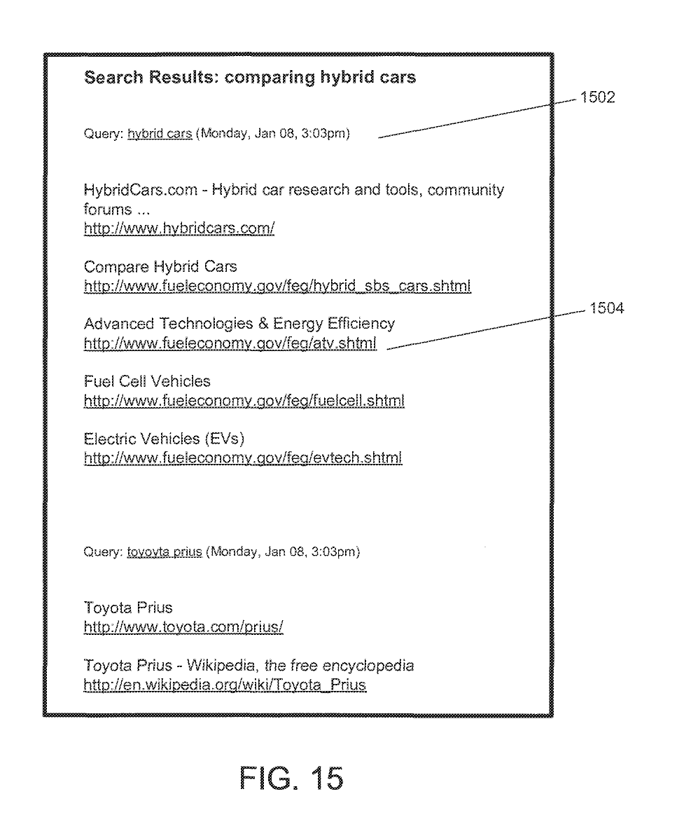

Often the goal of a search is to prepare a summary of results. Currently users have to copy and paste URL's from various sources into e-mail or hand-created documents, and it may be very difficult to re-create the search trail that a user used to get to those results. Clicking on a single button (FIG. 9, 914) in one embodiment, the UI of which is shown in FIG. 9, the exploratory search technique formats all of the results that a user has marked as relevant and puts them in a word processor document (they can also be routed to an e-mail address, web page, blog, or to other applications). A sample summary (automatically generated from the present exploratory search application with a single click) is shown in FIG. 15. Note that this sample summary includes the queries a user used to find relevant results 1502, which would help a second user with further searching, and it includes links to re-execute each query 1504.

A summary of the entire saved search session (particularly the queries used, the results and subsequently-navigated-to-pages identified as keepers, and any associated comments) can be exported as a web page, which itself could in the future be returned as a search result. For example, if the user conducts a search on the comparative fuel efficiency of various hybrid car models, other people who are conducting a similar search in the future might benefit from the work they have already done in formulating queries and screening results.

It should also be noted that any or all of the aforementioned alternate embodiments may be used in any combination desired to form additional hybrid embodiments. Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

Wherefore, what is claimed is:

1. A computer-implemented process for synthesizing a multi-query search comprising:
receiving multiple search queries from a user;
obtaining multiple search results using the multiple search queries;
automatically manipulating the multiple search results to provide more relevant synthesized search results of the search queries to a user; and
displaying the synthesized search results to a user.

2. The computer-implemented process of claim 1 further comprising storing the multiple search queries, the multiple search results and the synthesized search results.

3. The computer-implemented process claim 2 further comprising:
receiving one or more additional search queries from a user;
receiving additional search results based on the one or more additional search queries; and
using the stored multiple search queries, the stored multiple search results and the stored synthesized search results to create new synthesized search results.

4. The computer-implemented process of claim 1 wherein the multiple search queries are conducted over multiple distinct and separate time periods wherein a multi-query search has been suspended and resumed.

5. The computer-implemented process of claim 1 wherein the multiple search queries are conducted using multiple search engines.

6. The computer-implemented process of claim 1 wherein the beginning of the multiple search queries to be used in manipulating the multiple search results are defined by a user by:
activating a new investigation indicator that indicates the start of a search; and
annotating all subsequent search queries and search results with an investigation identifier;
using only the search queries and search results annotated with the investigation identifier in manipulating the multiple search results to create the synthesized search results.

7. The computer-implemented process of claim 1 wherein the beginning and end of the multiple search queries are retroactively defined by:
a user selecting a subset of search queries from the multiple search queries;
automatically annotating the selected search queries and associated search results with an investigation identifier;
using only the search queries and search results annotated with the investigation identifier in manipulating the multiple search results to create the synthesized search results.

8. The computer-implemented process of claim 1 wherein the multiple search results that are used to create the synthesized search results are automatically chosen by one of:
selecting search results that are associated with search queries that overlap in terms or proximity in a predefined network or semantic relationships between queries;
selecting search queries that overlap in results returned for recent queries; or
selecting search queries that are in close time.

9. The computer-implemented process of claim 1 wherein one or more of the multiple search queries are stored and re-executed at a later time to find new search results.

10. The computer-implemented process of claim 1 wherein one or more of the multiple search queries are stored and automatically re-executed at specified intervals to find new search results.

11. The computer-implemented process of claim 1 wherein the multiple search queries and associated search results are stored and presented to the user for further viewing or manipulation later in time.

12. The computer-implemented process of claim 1 wherein the synthesis of the multiple search results comprises allowing a user to mark each of said multiple search results as supporting, refuting or not pertaining to a user-specified hypothesis specifying a question to be answered by search results obtained from the multiple search queries.

13. The computer-implemented process of claim 1 wherein the synthesis of the multiple search results comprises eliminating redundant search results from display to a user.

14. The computer-implemented process of claim 1 wherein the synthesis of multiple search results comprises automatically preparing a summary of the search.

15. The computer-implemented process of claim 1 wherein the synthesis of multiple search results comprises automatically incorporating a user's annotations into the synthesized search results.

16. A system for improving search results obtained by using a multi-query search, comprising:
a general purpose computing device;
a computer program comprising program modules executable by the general purpose computing device, wherein the computing device is directed by the program modules of the computer program to,
receive multiple search queries from a user;
store the multiple search queries;
obtain multiple search results from the multiple search queries;
store the multiple search results; and
automatically manipulate the multiple search queries and multiple search results to provide more relevant synthesized results to a user; and
display the synthesized search results to the user.

17. The system of claim 16 wherein the multiple search queries are simultaneously conducted using multiple search engines.

18. A computer-implemented process for improving search results obtained by using a multi-query search, comprising:
receiving multiple search queries from a user;
obtaining multiple search results from the multiple search queries;
automatically manipulating the multiple search results to provide more relevant synthesized search results using the multiple search queries and the multiple search results.

19. The computer-implemented process of claim 18 wherein a user specifies which of the multiple search results are to be saved for later viewing.

20. The computer-implemented process of claim 18 wherein one or more of the multiple searches are implicitly saved for later viewing if a user:
spends longer than a specified time period viewing a given search result;
performs complex interactions with a given search result; or
follows a link from another search result that has previously been saved for later viewing to a given search result.
